(19) United States
(12) Patent Application Publication
(10) Pub. No.: US 2023/0140628 A1
(43) Pub. Date: May 4, 2023

(54) NOVEL BUFFER FORMAT FOR A TWO-STAGE VIDEO ENCODING PROCESS

(71) Applicant: Meta Platforms, Inc., Menlo Park, CA (US)

(72) Inventors: Srikanth Alaparthi, Fremont, CA (US); Karunakar Reddy Rachamreddy, San Jose, CA (US); Yunqing Chen, Los Altos, CA (US); Visalakshi Vaduganathan, Fremont, CA (US); Chung-Fu Lin, Menlo Park, CA (US); Harikrishna Madadi Reddy, San Jose, CA (US)

(21) Appl. No.: 17/519,199

(22) Filed: Nov. 4, 2021

(51) Int. Cl. H04N 19/146; H04N 19/18; H04N 19/176; H04N 19/46

(52) U.S. Cl. CPC H04N 19/146; H04N 19/18; H04N 19/176; H04N 19/46

(57) ABSTRACT

A system that includes a pixel processing stage decoupled from an entropy coding stage is disclosed. The pixel processing results comprise quantized transform coefficients that are divided into component blocks. The component blocks including non-zero data are identified. An optimized version of the pixel processing results for storage in a buffer storage is generated. The optimized version includes an identification of which of the component blocks include non-zero data, and the optimized version includes contents of one or more of the component blocks that include non-zero data, without including contents of one or more of the component blocks that only include zero data. The optimized version of the pixel processing results is provided for storage in the buffer storage. The optimized version of the pixel processing results from the buffer storage is received and processed to generate an unpacked version of the pixel processing results for use in entropy coding.

### BACKGROUND

A video coding format is a content representation format for storage or transmission of digital video content (such as in a data file or bitstream). It typically uses a standardized video compression algorithm. Examples of video coding formats include H.262 (MPEG-2 Part 2), MPEG-4 Part 2, H.264 (MPEG-4 Part 10), HEVC, (H.265), Theora, Real Video RV40, VP9 and AV1. A video codec is a device or software that provides encoding and decoding for digital video. Most codecs are typically implementations of video coding formats.

Recently, there has been an explosive growth of video usage on the Internet. Some websites (e.g., social media websites or video sharing websites) may have billions of users and each user may upload or download one or more videos each day. When a user uploads a video from a user device onto a website, the website may store the video in one or more different video coding formats, each being compatible with or more efficient for a certain set of applications, hardware, or platforms. Therefore, higher video compression rates are desirable. For example, VP9 offers up to 50% more compression compared to its predecessor. However, with higher compression rates comes higher computational complexity; therefore, improved hardware architecture and techniques in video coding would be desirable.

### BRIEF DESCRIPTION OF THE DRAWINGS

Various embodiments of the disclosure are disclosed in the following detailed description and the accompanying drawings.

FIG. 1 illustrates a block diagram of an embodiment of a video encoder 100.

FIG. 2 illustrates an exemplary video encoding system 200 that is categorized into two processing stages.

FIG. 3 illustrates an exemplary video encoding system 300 that includes two processing stages that are decoupled from each other.

FIG. 4 illustrates an exemplary video encoding process 400 that includes two processing stages that are decoupled from each other.

FIG. 5 illustrates an exemplary 16×16 PU 500 that is divided into sixteen 4×4 blocks of coefficients in a raster scan order.

FIG. 6 illustrates an exemplary table 600 showing the number of CBF bits that are needed for different PU sizes.

FIG. 7 illustrates an exemplary video encoding system 700 that enables multi-pipe parallel encoding.

FIG. 8 illustrates one example of the packets that are packed into a buffer in a buffer format 800 for H.264.

FIG. 9 illustrates one example of the packets that are packed into a buffer in a buffer format 900 for VP9.

### DETAILED DESCRIPTION

The disclosure can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the disclosure may take, may be referred to as techniques. In general, the order of the steps of disclosed processes may be altered within the scope of the disclosure. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the disclosure is provided below along with accompanying figures that illustrate the principles of the disclosure. The disclosure is described in connection with such embodiments, but the disclosure is not limited to any embodiment. The scope of the disclosure is limited only by the claims and the disclosure encompasses numerous alternatives, modifications and equivalents. Numerous specific details are set forth in the following description in order to provide a thorough understanding of the disclosure. These details are provided for the purpose of example and the disclosure may be practiced according to the claims without some or all of these specific details. For the purpose of clarity, technical material that is known in the technical fields related to the disclosure has not been described in detail so that the disclosure is not unnecessarily obscured.

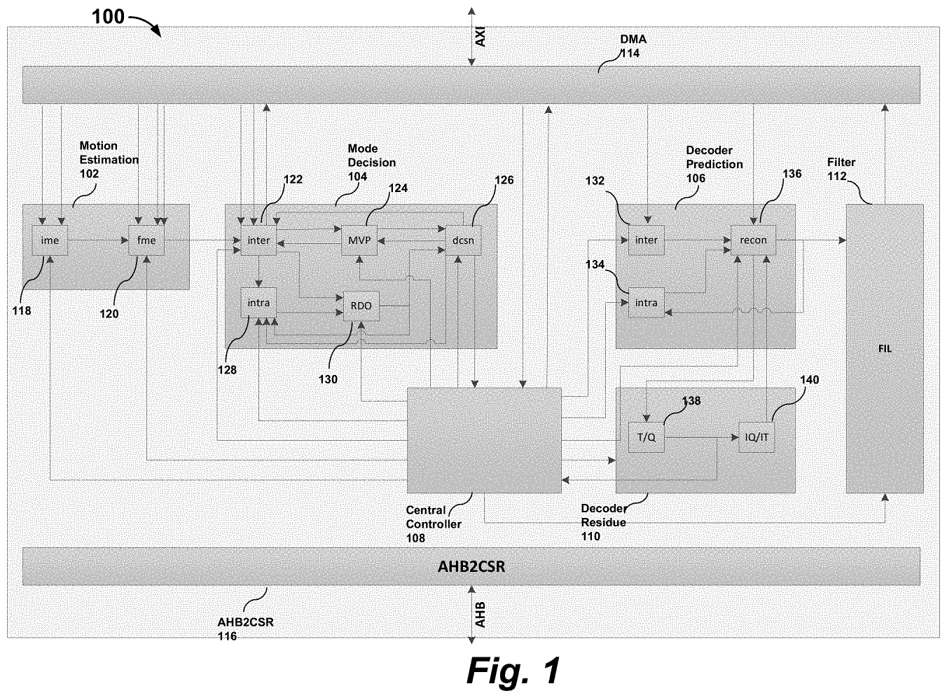

FIG. 1 illustrates a block diagram of an embodiment of a video encoder 100. For example, video encoder 100 supports the video coding format H.264 (MPEG-4 Part 10). However, video encoder 100 may also support other video coding formats as well, such as H.262 (MPEG-2 Part 2), MPEG-4 Part 2, HEVC (H.265). Theora, RealVideo RV40, AV1 (Alliance for Open Media Video 1), and VP9.

Video encoder 100 includes many modules. Some of the main modules of video encoder 100 are shown in FIG. 1. As shown in FIG. 1, video encoder 100 includes a direct memory access (DMA) controller 114 for transferring video data. Video encoder 100 also includes an AMBA (Advanced Microcontroller Bus Architecture) to CSR (control and status register) module 116. Other main modules include a motion estimation module 102, a mode decision module 104, a decoder prediction module 106, a central controller 108, a decoder residue module 110, and a filter 112.

Video encoder 100 includes a central controller module 108 that controls the different modules of video encoder 100, including motion estimation module 102, mode decision module 104, decoder prediction module 106, decoder residue module 110, filter 112, and DMA controller 114. Central controller 108 controls decoder prediction module 106, decoder residue module 110, and filter 112 to perform a number of steps using the mode selected by mode decision module 104. This generates the inputs to an entropy coder that generates the final bitstream.

Video encoder 100 includes a motion estimation module 102. Motion estimation module 102 includes an integer motion estimation (IME) module 118 and a fractional motion estimation (FME) module 120. Motion estimation module 102 determines motion vectors that describe the transformation from one image to another, for example, from one frame to an adjacent frame. A motion vector is a two-dimensional vector used for inter-frame prediction; it refers the current frame to the reference frame, and its coordinate values provide the coordinate offsets from a location in the current frame to a location in the reference frame. Motion estimation module 102 estimates the best motion vector, which may be used for inter prediction in mode decision module 104. An inter coded frame is divided into blocks known as macroblocks. Instead of directly encoding the raw pixel values for each block, the encoder will try to find a block similar to the one it is encoding on a previously encoded frame, referred to as a reference frame. This process is done by a block matching algorithm. If the encoder succeeds on its search, the block could be encoded by a vector, known as a motion vector, which points to the position of the matching block at the reference e. The process of motion vector determination is called motion estimation.

Video encoder 100 includes a mode decision module 104. The main components of mode decision module 104 include an inter prediction module 122, an intra prediction module 128, a motion vector prediction module 124, a rate-distortion optimization (RDO) module 130, and a decision module 126. Mode decision module 104 detects one prediction mode among a number of candidate inter prediction modes and intra prediction modes that gives the best results for encoding a block of video.

Decoder prediction module 106 includes an inter prediction module 132, an intra prediction module 134, and a reconstruction module 136. Decoder residue module 110 includes a transform and quantization module (T/Q) 138 and an inverse quantization and inverse transform module (IQ/IT) 140.

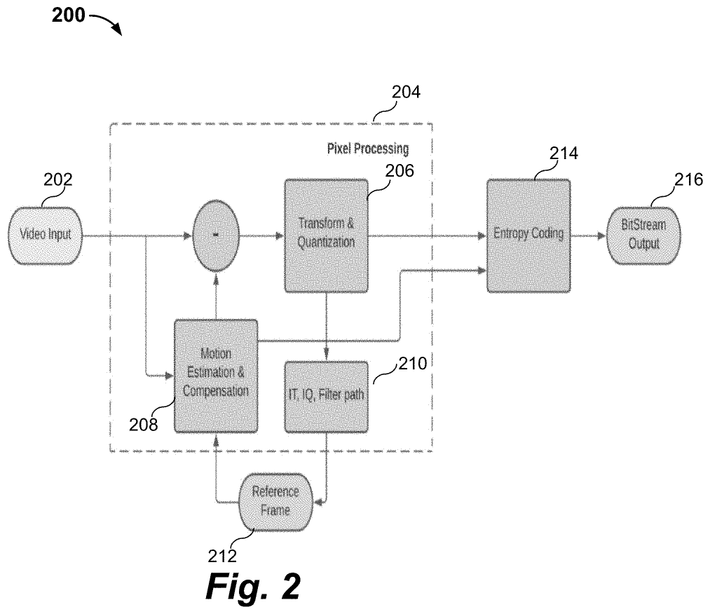

FIG. 2 illustrates an exemplary video encoding system 200 that is categorized into two processing stages. The first processing stage is a pixel processing stage 204, and the second processing stage is an entropy coding stage 214.

Pixel processing stage 204 includes a motion estimation and compensation module 208, a transform and quantization module 206, and an inverse quantization and inverse transform module 210. Video input frames 202 are processed by motion estimation and compensation module 208 where the temporal/spatial redundancy is removed. Residual pixels are generated by transform and quantization module 206. Reference frames 212 are sent by inverse quantization and inverse transform module 210 and received by motion estimation and compensation module 208. During the entropy coding stage 214, the generated residue along with the header info (e.g., motion vectors, prediction unit (PU) type, etc.) are converted to a video bit stream output 216 by applying codec specific entropy (syntax and variable length) coding.

Based on the pipeline design, pixel processing takes a fixed number of cycles to complete a frame. However, the entropy engine performance is variable, depending on the total number of non-zero residual coefficients in the frame. Therefore, a method that decouples these two stages would improve the throughput, frame rate, and the overall performance.

In the present application, a system that includes a pixel processing stage decoupled from a second entropy coding stage is disclosed. The system comprises a buffer storage. The system comprises a data packing hardware component. The data packing hardware component is configured to receive pixel processing results corresponding to a video. The pixel processing results comprise quantized transform coefficients corresponding to the video. The data packing hardware component is configured to divide the quantized transform coefficients into component blocks. The data packing hardware component is configured to identify which of the component blocks include non-zero data. The data packing hardware component is configured to generate an optimized version of the pixel processing results for storage in the buffer storage, wherein the optimized version includes an identification of which of the component blocks include non-zero data, and wherein the optimized version includes contents of one or more of the component blocks that include non-zero data, without including contents of one or more of the component blocks that only include zero data. The data packing hardware component is configured to provide for storage in the buffer storage the optimized version of the pixel processing results. The system further comprises a data unpacking hardware component configured to receive the optimized version of the pixel processing results from the buffer storage; and process the optimized version of the pixel processing results to generate an unpacked version of the pixel processing results for use in entropy coding.

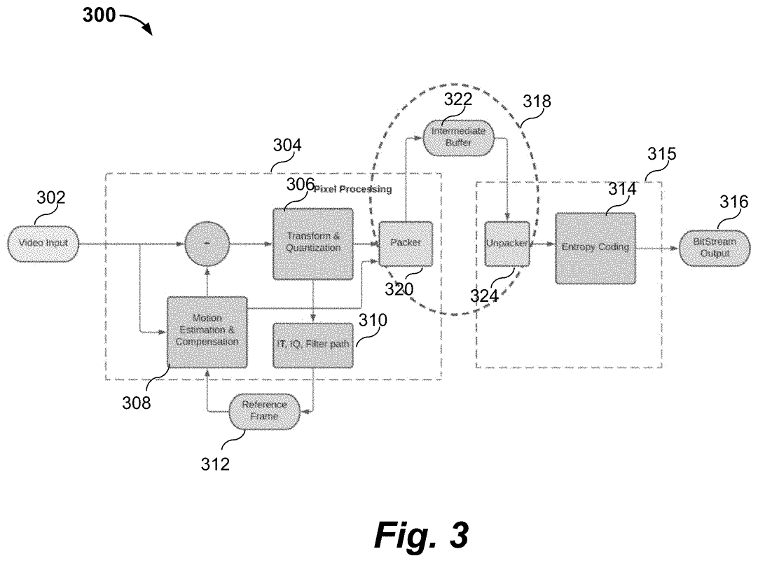

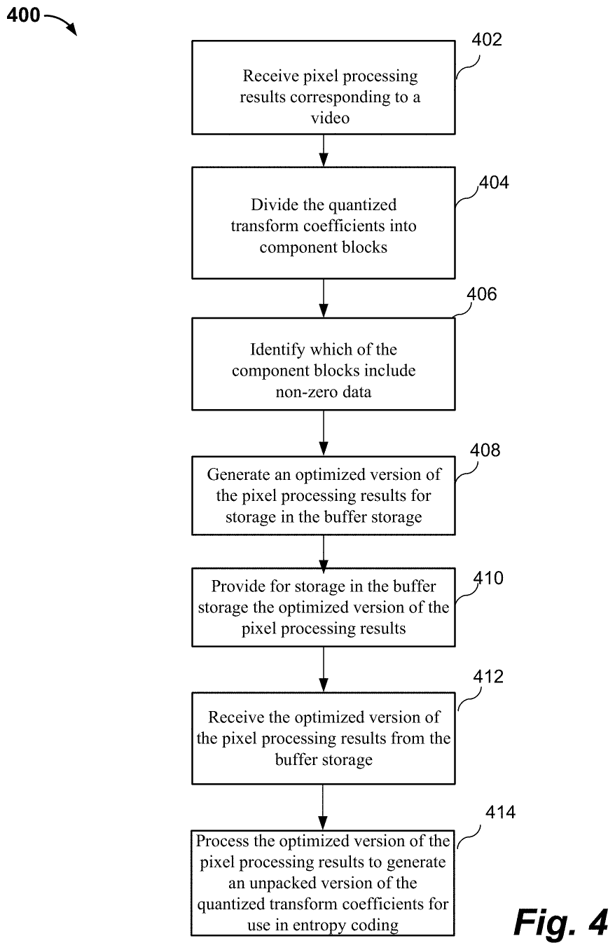

FIG. 3 illustrates an exemplary video encoding system 300 that includes two processing stages that are decoupled from each other. The first processing stage is a pixel processing stage 304, and the second processing stage is an entropy coding stage 315. FIG. 4 illustrates an exemplary video encoding process 400 that includes two processing stages that are decoupled from each other. In some embodiments, process 400 may be performed by system 300.

Pixel processing stage 304 includes a motion estimation and compensation module 308, a transform and quantization module 306, and an inverse quantization and inverse transform module 310. Video input frames 302 are processed by motion estimation and compensation module 308 where the temporal/spatial redundancy is removed. Residual pixels are generated by transform and quantization module 306. Reference frames 312 are sent by inverse quantization and inverse transform module 310 and received by motion estimation and compensation module 308. During the entropy coding stage 315, the generated residue along with the header info (e.g., motion vectors, PU type, etc.) are converted to a video bit stream output 316 by applying codec specific entropy (syntax and variable length) coding.

As shown in FIG. 3, to achieve the decoupling, an additional buffering stage 318 is added. The output of pixel processing stage 304 is packed in a specific format by a data packing module 320 and stored in an external intermediate buffer 322. At a later time, a data unpacking module 324 in entropy coding stage 315 reads from external intermediate buffer 322 and unpacks the data. The unpacked data is then processed by entropy coding module 314 to produce the final bitstream output 316.

There are many advantages of decoupling the two processing stages by packing and unpacking the data sent between the two stages according to an optimized buffer format. The data packing module 320 may be configured to pack the header and residue together efficiently in an optimized buffer format before writing them out to the external buffer, thereby minimizing the write/read bandwidth without adding much hardware design overhead.

Video encoding involves macroblock (MB) or superblock (SB) processing, in which a MB/SB is partitioned into prediction units (PUs) for motion compensation. For each of these PUs, the data at the output of the pixel processing stage 304 includes a header and the residue. The header information includes the PU size, PU type, motion vector (two references, L0/L1), intra modes, etc. The residue includes the coefficients after quantization. Most of these quantized transform coefficients (mainly the higher order coefficients) are zeros. This is because the transform concentrates the energy in only a few significant coefficients, and after quantization, the non-significant transform coefficients are reduced to zeros.

The buffer format includes an explicit header information that is sent out every PU. The header includes an additional bit flag (also referred to as the coded block flag (CBF)) corresponding to every 4×4 block in that PU. The CBF corresponding to a particular 4×4 block is set to 1 if there is at least one non-zero coefficient in that 4×4 block. The buffer format also includes the residue. However, only the 4×4 blocks of the residue with at least one non-zero coefficient within its corresponding 4×4 block are sent out.

As shown in FIG. 4, at step 402, pixel processing results corresponding to a video are received. The pixel processing results are received by data packing module 320 from transform and quantization module 306. At step 404, the quantized transform coefficients are divided by data packing module 320 into component blocks. For example, the component blocks may be 4×4 blocks of coefficients. At step 406, the component blocks including non-zero data are identified. At step 408, an optimized version of the pixel processing results for storage in the buffer storage is generated. The optimized version includes an identification of which of the component blocks include non-zero data. For example, the identification includes the coded block flags (CBF) corresponding to the 4×4 blocks in the PU. The optimized version includes contents of one or more of the component blocks that include non-zero data without including contents of one or more of the component blocks that only include zero data. Only the 4×4 blocks with non-zero coefficients are packed and sent out. The remaining 4×4 blocks with zero coefficients are skipped and are not packed and sent out. At step 410, the optimized version of the pixel processing results is provided for storage in the buffer storage. The optimized version is stored in intermediate buffer 322. At step 412, the optimized version of the pixel processing results from the buffer storage is received by data unpacking module 324. At step 414, the optimized version of the pixel processing results is processed by unpacking module 324 to generate an unpacked version of the pixel processing results for use in entropy coding.

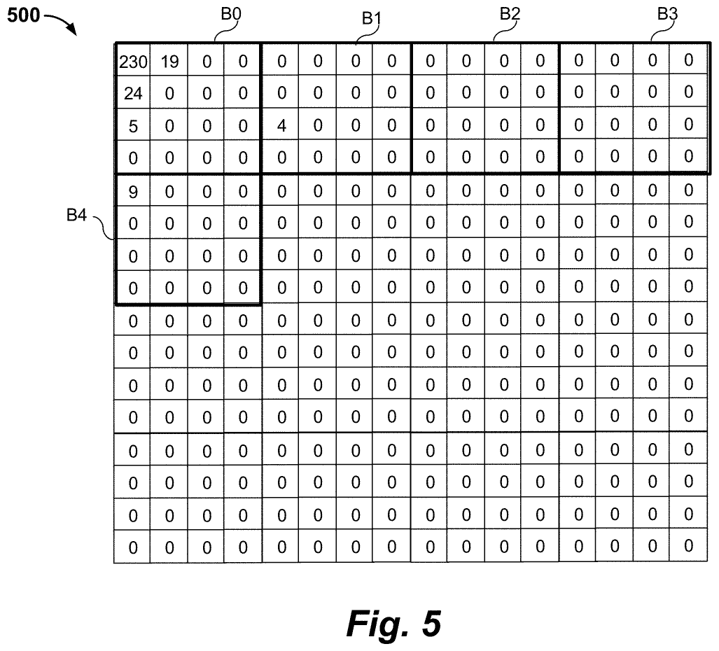

FIG. 5 illustrates an exemplary 16×16 PU 500 that is divided into sixteen 4×4 blocks of coefficients in a raster scan order. As shown in FIG. 5, B0, B1, B2, B3, and B4 are the first five 4×4 blocks of coefficients in the raster scan order. B0, B1, and B4 each have one or more non-zero coefficients. For example, B0 has four non-zero coefficients. B1 and B4 each have one non-zero coefficient. The remaining 4×4 blocks in the PU each have only zero coefficients.

In the header, there are 16 CBF flags that are sent as follows: {0,0,0,0, 0,0,0,0, 0,0,0,1, 0,0,1,1}. Only the coefficients for B0, B1 and B4 are packed and sent out. The remaining 4×4 blocks with zero coefficients are skipped and are not packed and sent out. As shown in this example, though the header requires an additional 16-bits overhead, the skipping of the thirteen 4×4 blocks of zero coefficients of the residue achieves a savings of 3328 (13 blocks*16 coefficients*16 bits/coefficient), where each coefficient is 16-bit wide for an 8-bit video input. The overall savings is therefore 3312 bits.

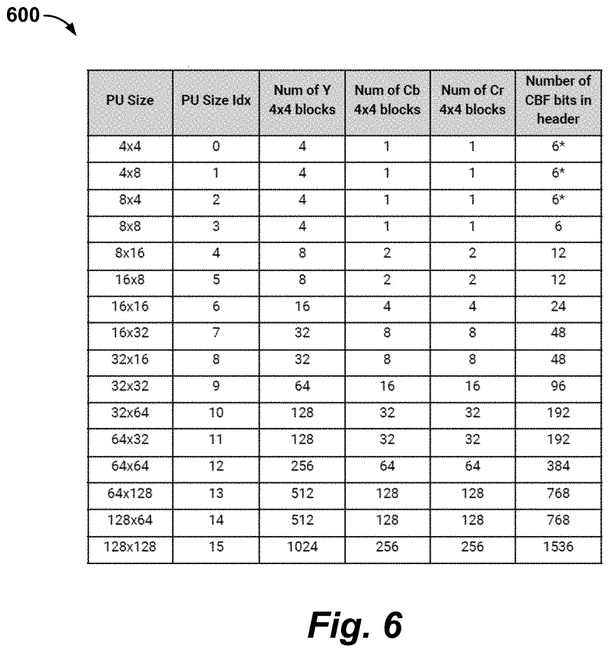

FIG. 6 illustrates an exemplary table 600 showing the number of CBF bits that are needed for different PU sizes. Different codecs have different PU sizes. In H.264, the PU sizes are up to 16×16. In VP9, the PU sizes are up to 64×64. In AV1, the PU sizes are up to 128×128. Each PU size is indicated by a PU index. For example, a 4×4 PU size is indicated by a PU index of 0, a 4×8 PU size is indicated by a PU index of 1, and so forth. The PU index is sent as part of the header. As shown in table 600, for an 8×8 PU size, the number of Y 4×4 blocks is 4, the number of Cb 4×4 blocks is 1, and the number of Cr 4×4 blocks is 1, and therefore the number of CBF bits is 4+1+1=6 bits. Note that for 4×4, 4×8, and 8×4 PU sizes, the packets are at the 8×8 level only, and therefore the number of CBF flags is 6.

One of the key goals of packing the header and the residue values in the buffer format is bandwidth optimization through lossless packing. Additional features of the buffer format are described below.

One feature of the buffer format is that the packed data is byte-aligned. While the header or the residue is being packed, if any packet storing a particular type of information ends in an arbitrary bit position (i.e., not a multiple of 8), additional zeros are padded to make the packet byte-aligned. In other words, if the portion storing a particular type of information does not end at a byte boundary, additional zeros are padded to make the portion storing the particular type of information to end at the byte boundary. For example, if the CBF bits or certain types of information bits packed into the header are not byte-aligned, then additional zero bits are padded to make the group of information bits byte-aligned. The advantage of this is that it drastically reduces the complexity of the extractor at the entropy coding stage 315, where a pointer may be moved a predefined fixed number of bytes for each packet.

Another feature of the buffer format is that only blocks of the residue with at least one non-zero coefficient are packed and sent to the external intermediate buffer. Instead of a pixel level, a 4×4 level granularity is used. Each 4×4 block is sent out only if there exists at least one non-zero coefficient, otherwise the block is skipped. As the data unpacking module 324 receives the CBF information as part of the header, the module may receive the residue packets corresponding to the non-zero CBF flags and auto fill the missing coefficients with zeroes before sending the extracted data to the entropy engine.

The syntaxes and the number of packets that are packed and sent to the external intermediate buffer are optimized. The header information may be scaled based on the encoder. Additional packets may be added as needed. For example, for AV1, additional information including PU shapes/sizes, transform types, and palette information may be added. Optimizations may be done based on the encoder design choices. At least a portion of the pixel processing results for use in entropy coding is not included in the optimized version of the pixel processing results. The skipped portion of the pixel processing results may be derived by the data unpacking hardware component based on video encoding features supported by the system, and the skipped portion of the pixel processing results is included in the unpacked version of the pixel processing results that is sent to the entropy engine. For example, if the encoder only supports certain features or has specific limitations, this information may be used to derive some of the data, thereby allowing the data to be skipped from being packed and sent to the external intermediate buffer.

For example, in some embodiments, the encoder uses the maximum possible square transform size within each PU. For a square PU, the transform unit (TU) size is the same as the PU size. For a rectangular PU, the TU size is half of the PU size. Since the TU size may be derived from the encoder design, the TU size is not part of the header.

Some packets are not sent out in the header because they are not needed based on the configuration or modes. For example, in the H.264 buffer format, for direct mode, only PU_CFG and INTER_CFG packets are sent. If a MB is skipped, only the MB_CFG packet is sent. As the data is tightly packed, the data unpacking module 324 can use the information in the current packet to decide the interpretation of the next packet. In some embodiments, for VP9 B frames, PU sizes that are smaller than 16×16 are not supported. Only packets that are needed are sent out. This reduces the overall number of packets sent per superblock.

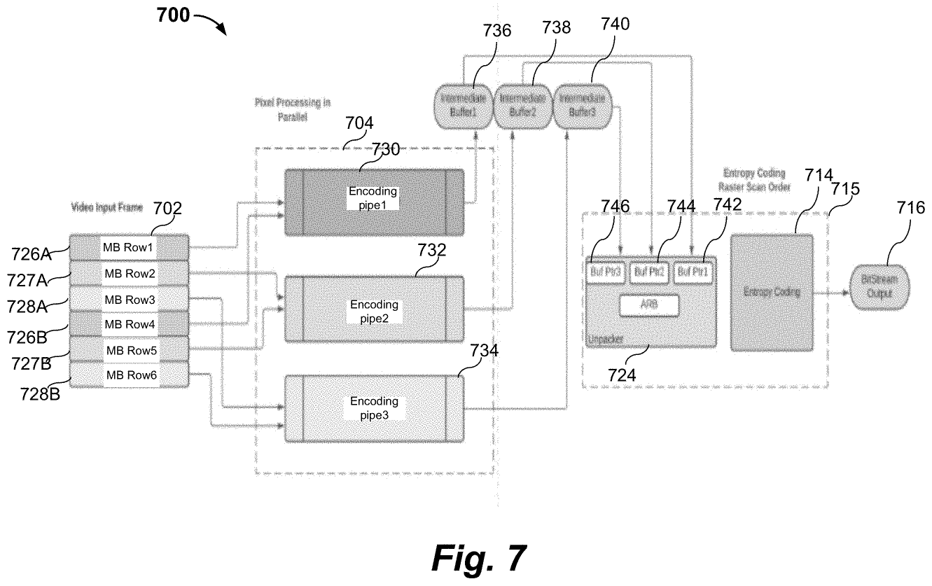

FIG. 7 illustrates an exemplary video encoding system 700 that enables multi-pipe parallel pixel processing. System 700 includes a pixel processing stage 704 and an entropy coding stage 715. Video input frames 702 are processed by pixel processing stage 704. During the entropy coding stage 715, the generated residue along with the header info (e.g., motion vectors, PU type, etc.) are converted to a video bit stream output 716 by applying codec specific entropy (syntax and variable length) coding.

As shown in FIG. 7, to achieve the decoupling, the output of pixel processing stage 704 is packed in a specific format and stored in three intermediate buffers (736, 738, and 740). At a later time, a data unpacking module 724 at entropy coding stage 715 reads from the intermediate buffers (736, 738, and 740) and unpacks the data. The unpacked data is then processed by entropy coding module 714 to produce the final bitstream output 716.

As the format is independent for each PU, each MB row may be encoded in parallel by multi-pipe parallel pixel processing. As shown in FIG. 7, pixel processing stage 704 may work in parallel on each MB row and send the corresponding outputs to three different buffers simultaneously. The three buffers are separate portions of the buffer storage, and each buffer corresponds to a parallel pixel processing pipe. For example, MB row1 726A is processed by parallel encoding pipe 730; MB row2 727A is processed by parallel encoding pipe 732, and MB row3 728A is processed by parallel encoding pipe 734. Parallel encoding pipe 730 sends its output to an intermediate buffer1 736; parallel encoding pipe 732 sends its output to an intermediate buffer2 738; and parallel encoding pipe 734 sends its output to an intermediate buffer3 740. Similarly, MB row4 726B is processed by parallel encoding pipe 730; MB rows 727B is processed by parallel encoding pipe 732, and MB row6 728B is processed by parallel encoding pipe 734. Parallel encoding pipe 730 sends its output to intermediate buffer1 736; parallel encoding pipe 732 sends its output to intermediate buffer2 738; and parallel encoding pipe 734 sends its output to intermediate buffer3 740.

Though parallel processing may be performed during the pixel processing stage 704, data is processed in the raster scan order (the original image scan order) during the entropy coding stage 715. This requires data unpacking module 724 to switch between the three buffers (736, 738, and 740) while reading from the buffers. A dedicated pointer for each buffer is maintained by the data unpacking module 724. For example, a buffer pointer1 742 is the pointer for intermediate buffer1 736; a buffer pointer2 744 is the pointer for intermediate buffer2 738; and a buffer pointer3 746 is the pointer for intermediate buffer3 740.

Data unpacking module 724 initially starts with reading intermediate buffer1 736. As data unpacking module 724 reads from the buffer, it keeps track of the MBs being processed based on the header format information. Once data unpacking module 724 has finished reading the end of the MB row1 726A, it stores buffer pointer1 742 and switches to reading intermediate buffer2 738 using buffer pointer2 744. Once data unpacking module 724 has finished reading the end of MB row2 727A, it stores buffer pointer2 744 and switches to reading intermediate buffer3 740 using buffer pointer3 746. And once data unpacking module 724 has finished reading the end of MB row3 728A, it stores buffer pointer3 746 and switches to reading intermediate buffer1 736 by restoring the previously stored buffer pointer1 742.

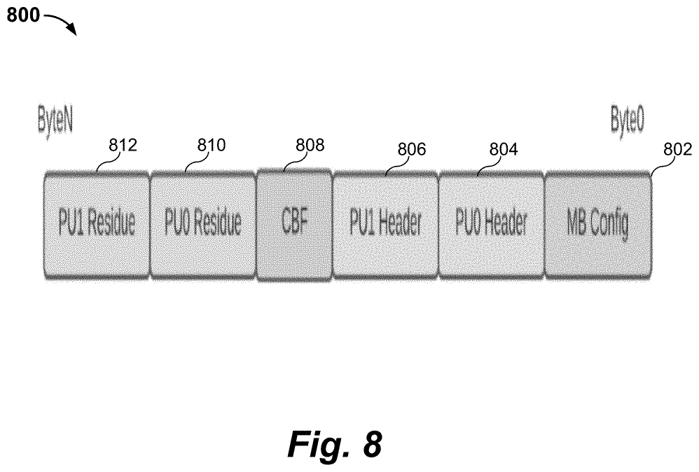

FIG. 8 illustrates one example of the packets that are packed into a buffer in a buffer format 800 for H.264. In this example, there are 2 PUs (PU0 and PU1) in the MB. The first packet is a MB config packet 802, which is sent once per MB. Then, one or more PU header packets (PU0 header 804 and PU1 header 806) within the MB (16×16 size) are packed. Next, a CBF packet 808 is packed. Then, PU0 residue 810 and PU1 residue 812 are packed.

In some embodiments, MB_CFG and CBF_CFG are always present in the buffer format 800, but the combination of other packets in each PU header is variable depending on the type of the PU. For example, if the PU type is INTRA, the PU header has two portions: INTRA_CFG and PU_CFG. If the PU type is INTER and the mode is Direct/Skip mode, the PU header has two portions: PU_INTER_CFG and PU_CFG. If the PU type is INTER with only L0 reference, the PU header has three portions: INTER_MVD_L0_CFG, PU_INTER_CFG, and PU_CFG. If the PU type is INTER with only L1 reference, the PU header has three portions: INTER_MVD_L1_CFG, PU_INTER_CFG, and PU_CFG. If the PU type is INTER with bi-reference, the PU header has four portions: INTER_MVD_L1_CFG, INTER_MVD_L0_CFG, PU_INTER_CFG, and PU_CFG. The H.264 CBF_CFG is sent once per MB, including a total of 27 bits—16 Y, 4 Cb, 4Cr, 1 Y_DC, 1 Cb_DC, and 1 Cr_DC.

In some embodiments, superblocks are divided into prediction units, and each prediction unit may have one or multiple transform units. The residue may be packed in 4×4 blocks in raster order (left to right and top to bottom). Each 4×4 block is sent out only if there exists at least one non-zero coefficient, otherwise the block is skipped. As the data unpacking module 724 has the CBF information as part of the header, it may extract the residue packets corresponding to the non-zero CBF flags and pack them into the buffer. The data unpacking module 724 also packs zero bits into the buffer, and these zero bits are the residue packets corresponding to the zero CBF flags.

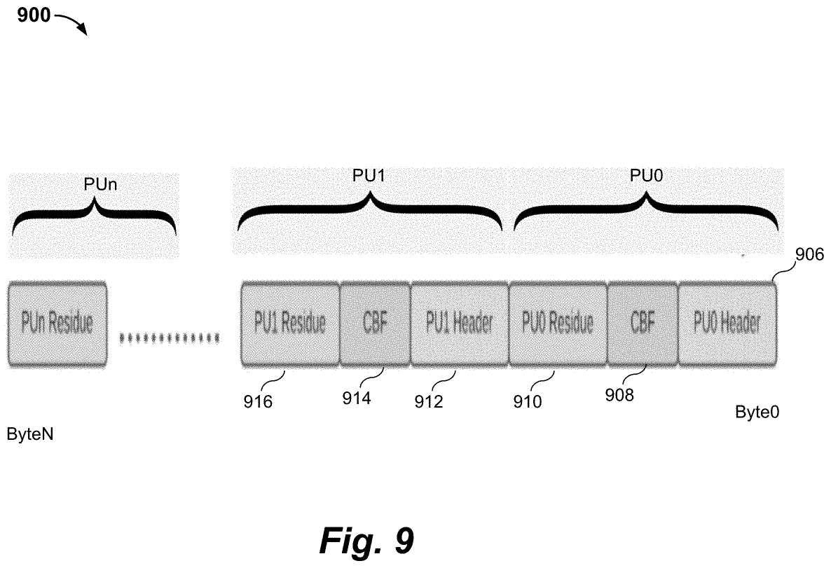

FIG. 9 illustrates one example of the packets that are packed into a buffer in a buffer format 900 for VP9. In some embodiments, a fixed quantization parameter (QP) is used, and the QP is provided to the entropy engine through a CSR register. Therefore, there is no need to send an additional superblock (SB) 64×64 level packet. In some embodiments, the header and residue for each PU is sent together. For example, as shown in FIG. 9, the information for PU0 in the buffer includes PU0_header 906, CBF 908, and PU0_residue 910. Next, the information for PU1 that is packed in the buffer includes PU1_header 912, CBF 914, and PU1_residue 916. The information for the remaining PUs is packed in the buffer, with the information for the nth PU being packed at the end of the buffer.

In some embodiments, the PDU header for VP9 always includes the PU_CFG and CBF_CFG packets, but the combination of other packets in each PU header is variable depending on the type of the PU or the skip information.

In some embodiments, superblocks are divided into prediction units, and each prediction unit may have one or multiple transform units. The residue may be packed in 4×4 blocks in raster order (left to right and top to bottom). Each 4×4 block is sent out only if there exists at least one non-zero coefficient, otherwise the block is skipped. As the data unpacking module 724 has the CBF information as part of the header, it may extract the residue packets corresponding to the non-zero CBF flags and pack them into the buffer. The data unpacking module 724 also packs zero bits into the buffer, and these zero bits are the residue packets corresponding to the zero CBF flags.

Although the foregoing embodiments have been described in some detail for purposes of clarity of understanding, the disclosure is not limited to the details provided. There are many alternative ways of implementing the disclosure. The disclosed embodiments are illustrative and not restrictive.

What is claimed is:

1. A system, comprising:
a buffer storage;
a data packing hardware component configured to:
receive pixel processing results corresponding to a video, wherein the pixel processing results comprise quantized transform coefficients corresponding to the video;
divide the quantized transform coefficients into component blocks;
identify which of the component blocks include non-zero data;
generate an optimized version of the pixel processing results for storage in the buffer storage, wherein the optimized version includes an identification of which of the component blocks include non-zero data, and wherein the optimized version includes contents of one or more of the component blocks that include non-zero data, without including contents of one or more of the component blocks that only include zero data; and
provide for storage in the buffer storage the optimized version of the pixel processing results; and
a data unpacking hardware component configured to:
receive the optimized version of the pixel processing results from the buffer storage; and
process the optimized version of the pixel processing results to generate an unpacked version of the pixel processing results for use in entropy coding.

2. The system of claim 1, wherein the optimized version includes a header that includes information bits associated with the pixel processing results.

3. The system of claim 2, wherein the information bits include one or more of the following:
prediction unit (PU) size, PU type, motion vector, and intra mode.

4. The system of claim 1, wherein the identification of which of the component blocks include non-zero data comprises one or more coded block flag (CBF) bits, wherein a CBF bit corresponding to a component block that is set to one indicates that the component block includes at least one non-zero quantized transform coefficient.

5. The system of claim 1, wherein the contents of the one or more of the component blocks that include non-zero data comprise the quantized transform coefficients corresponding to the one or more of the component blocks.

6. The system of claim 1, wherein in the event a portion of the optimized version of the pixel processing results storing a particular type of information is not byte-aligned, additional zero bits are padded to make the portion of the optimized version of the pixel processing results storing the particular type of information to be byte-aligned.

7. The system of claim 1, wherein at least a portion of the pixel processing results for use in the entropy coding is not included in the optimized version of the pixel processing results, and wherein the at least a portion of the pixel processing results for use in the entropy coding is derived by the data unpacking hardware component based on video encoding features supported by the system, and wherein the at least a portion of the pixel processing results for use in the entropy coding is included in the unpacked version of the pixel processing results for use in the entropy coding.

8. The system of claim 1, wherein at least a portion of the pixel processing results for use in the entropy coding is not included in the optimized version of the pixel processing results, and wherein the at least a portion of the pixel processing results for use in the entropy coding is derived by the data unpacking hardware component based on configurations or modes of the system, and wherein the at least a portion of the pixel processing results for use in the entropy coding is included in the unpacked version of the pixel processing results for use in the entropy coding.

9. The system of claim 1, further comprising a multi-pipe parallel pixel processing hardware component configured to:
receive a video input frame of the video;
process in parallel different portions of the video input frame of the video by parallel pixel processing pipes; and
send the pixel processing results from the parallel pixel processing pipes to the data packing hardware component, wherein the data packing hardware component is configured to:
provide the optimized version of the pixel processing results for storage in separate portions of the buffer storage, wherein a separate portion of the buffer storage corresponds to a parallel pixel processing pipe.

10. The system of claim 9, wherein macroblock rows of pixels are processed in parallel by the parallel pixel processing pipes and wherein the data unpacking hardware component is configured to receive and process the optimized version of the pixel processing results from the separate portions of the buffer storage in a raster scan order.

11. A method, comprising:
receiving by a data packing module pixel processing results corresponding to a video, wherein the pixel processing results comprise quantized transform coefficients corresponding to the video;
dividing by the data packing module the quantized transform coefficients into component blocks;
identifying by the data packing module which of the component blocks include non-zero data;
generating by the data packing module an optimized version of the pixel processing results for storage in a buffer storage, wherein the optimized version includes an identification of which of the component blocks include non-zero data, and wherein the optimized version includes contents of one or more of the component blocks that include non-zero data, without including contents of one or more of the component blocks that only include zero data;
providing by the data packing module for storage in the buffer storage the optimized version of the pixel processing results;
receiving by a data unpacking module the optimized version of the pixel processing results from the buffer storage; and
processing by the data unpacking module the optimized version of the pixel processing results to generate an unpacked version of the pixel processing results for use in entropy coding.

12. The method of claim 11, wherein the optimized version includes a header that includes information bits associated with the pixel processing results.

13. The method of claim 11, wherein the identification of which of the component blocks include non-zero data comprises one or more coded block flag (CBF) bits, wherein a CBF bit corresponding to a component block that is set to one indicates that the component block includes at least one non-zero quantized transform coefficient.

14. The method of claim 11, wherein the contents of the one or more of the component blocks that include non-zero data comprise the quantized transform coefficients corresponding to the one or more of the component blocks.

15. The method of claim 11, wherein in the event a portion of the optimized version of the pixel processing results storing a particular type of information is not byte-aligned, padding additional zero bits to make the portion of the optimized version of the pixel processing results storing the particular type of information to be byte-aligned.

16. The method of claim 11, wherein at least a portion of the pixel processing results for use in the entropy coding is not included in the optimized version of the pixel processing results, and wherein the at least a portion of the pixel processing results for use in the entropy coding is derived by the data unpacking module based on supported video encoding features, and wherein the at least a portion of the pixel processing results for use in the entropy coding is included in the unpacked version of the pixel processing results for use in the entropy coding.

17. The method of claim 11, wherein at least a portion of the pixel processing results for use in the entropy coding is not included in the optimized version of the pixel processing results, and wherein the at least a portion of the pixel processing results for use in the entropy coding is derived by the data unpacking module based on configurations or modes, and wherein the at least a portion of the pixel processing results for use in the entropy coding is included in the unpacked version of the pixel processing results for use in the entropy coding.

18. The method of claim 11, further comprising:
receiving by a multi-pipe parallel pixel processing module a video input frame of the video;
processing in parallel different portions of the video input frame of the video by parallel pixel processing pipes;
sending the pixel processing results from the parallel pixel processing pipes to the data packing module; and
providing by the data packing module the optimized version of the pixel processing results for storage in separate portions of the buffer storage, wherein a separate portion of the buffer storage corresponds to a parallel pixel processing pipe.

19. The method of claim 18, further comprising:
processing in parallel macroblock rows by the parallel pixel processing pipes; and
receiving and processing by the data unpacking module the optimized version of the pixel processing results from the separate portions of the buffer storage in a raster scan order.

20. A system, comprising:
a processor configured to:
receive by a data packing module pixel processing results corresponding to a video, wherein the pixel processing results comprise quantized transform coefficients corresponding to the video;
divide by the data packing module the quantized transform coefficients into component blocks;
identify by the data packing module which of the component blocks include non-zero data;
generate by the data packing module an optimized version of the pixel processing results for storage in a buffer storage, wherein the optimized version includes an identification of which of the component blocks include non-zero data, and wherein the optimized version includes contents of one or more of the component blocks that include non-zero data, without including contents of one or more of the component blocks that only include zero data;
provide by the data packing module for storage in the buffer storage the optimized version of the pixel processing results;
receive by a data unpacking module the optimized version of the pixel processing results from the buffer storage; and
process by the data unpacking module the optimized version of the pixel processing results to generate an unpacked version of the pixel processing results for use in entropy coding; and
a memory coupled to the processor and configured to provide the processor with instructions.
